(19) United States
(12) Patent Application Publication
(10) Pub. No.: US 2026/0104661 A1
(43) Pub. Date: Apr. 16, 2026

(54) IMAGE FORMING APPARATUS INCLUDING PHOTOCONDUCTOR DRUM AND PRIMARY TRANSFER ROLLER

(71) Applicant: KYOCERA Document Solutions Inc., Osaka (JP)

(72) Inventors: Teppei SHIBUYA, Osaka (JP); Sadanori NAKAE, Osaka (JP); Ryosuke KIMURA, Osaka (JP)

(73) Assignee: KYOCERA Document Solutions Inc., Osaka (JP)

(21) Appl. No.: 19/340,175

(22) Filed: Sep. 25, 2025

(30) Foreign Application Priority Data
Sep. 27, 2024 (JP) 2024-169542

(51) Int. Cl. G03G 15/16; G03G 15/01

(52) U.S. Cl. CPC G03G 15/1615; G03G 15/162; G03G 15/0189

(57) ABSTRACT

An image forming apparatus includes a photoconductor drum, an intermediate transfer belt that moves in contact with the photoconductor drum, and a primary transfer roller which is a metal roller. A first contact region, being a region on the photoconductor drum in contact with the intermediate transfer belt, and a second contact region, being a region on the primary transfer roller in contact with the intermediate transfer belt, are spaced from each other, and a summit of the primary transfer roller, protruding farthest toward the photoconductor drum, in a direction in which the photoconductor drum and the primary transfer roller are aligned across the intermediate transfer belt, is set to intrude on the photoconductor drum, via the intermediate transfer belt.

### INCORPORATION BY REFERENCE

This application claims priority to Japanese Patent Application No.2024-169542 filed on Sep. 27, 2024, the entire contents of which are incorporated by reference herein.

### BACKGROUND

The present disclosure relates to an image forming apparatus that forms an image by an electrophotographic method, and in particular to a technique to appropriately set a positional relation between a photoconductor drum and a primary transfer roller.

Existing electrophotographic image forming apparatuses are configured to form an electrostatic latent image on the surface of a photoconductor drum, apply toner to the electrostatic latent image thereby forming a toner image on the surface of the photoconductor drum, press an endless intermediate transfer belt against the photoconductor drum with a transfer roller, thereby transferring the toner image from the photoconductor drum to the intermediate transfer belt, as primary transfer, and transfer the toner image from the intermediate transfer belt to a recording sheet, as secondary transfer.

In many of known image forming apparatuses, the primary transfer roller is mounted such that the rotational center thereof is located on the downstream side with respect to the rotational center of the photoconductor drum, in the revolving direction of the intermediate transfer belt. The known intermediate transfer belt includes a base layer, and a surface layer provided on the outer circumferential surface of the base layer. In addition, the surface resistivity of the intermediate transfer belt is set so as to satisfy 0.75≤N/G≤1.2, where G represents the surface resistivity measured from the side of the outer circumferential surface of the intermediate transfer belt, and N represents the surface resistivity measured from the side of the inner circumferential surface of the intermediate transfer belt. With such a setting, splashing of the toner and appearance of a discharge crater can be prevented, despite the primary transfer roller being offset to the downstream side, with respect to the photoconductor drum.

### SUMMARY

The disclosure proposes further improvement of the foregoing technique.

In an aspect, the disclosure provides an image forming apparatus including a photoconductor drum, an intermediate transfer belt, and a primary transfer roller. The photoconductor drum carries an electrostatic latent image, which is developed into a toner image by application of toner. The intermediate transfer belt is made to move in contact with the photoconductor drum. The primary transfer roller is opposed to the photoconductor drum via the intermediate transfer belt, and presses the intermediate transfer belt against the photoconductor drum, thereby transferring the toner image on the photoconductor drum, to the intermediate transfer belt from the photoconductor drum. The primary transfer roller is a metal roller. A first contact region, being a region on the photoconductor drum in contact with the intermediate transfer belt, and a second contact region, being a region on the primary transfer roller in contact with the intermediate transfer belt, are kept from overlapping with each other. A summit of the primary transfer roller, protruding farthest toward the photoconductor drum, in a direction in which the photoconductor drum and the primary transfer roller are aligned across the intermediate transfer belt, is set to intrude into a side where the photoreceptor drum is located, via the intermediate transfer belt.

### BRIEF DESCRIPTION OF THE DRAWINGS

FIG. 1 is a cross-sectional view showing an image forming apparatus according to an embodiment of the disclosure;

FIG. 2 is a side view showing an intermediate transfer unit and related components, in the image forming apparatus according to the embodiment;

FIG. 3 is an enlarged schematic drawing showing an intermediate transfer belt, and one set of a primary transfer roller and a photoconductor drum, in the intermediate transfer unit;

FIG. 4 is a partially enlarged view from FIG. 3, showing a first contact region between the intermediate transfer belt and the photoconductor drum, a second contact region between the intermediate transfer belt and the primary transfer roller, and an overlapping region of the second contact region overlapping with the first contact region;

FIG. 5 presents conditions of an experiment 1;

FIG. 6A is a table showing whether banding has appeared through an experiment 1-1;

FIG. 6B is a table showing whether a drum ghost has appeared through an experiment 1;

FIG. 7A is a table showing whether banding has appeared through an experiment 1-2;

FIG. 7B is a table showing whether a drum ghost has appeared through the experiment 1;

FIG. 8A is a table showing whether banding has appeared through an experiment 1-3;

FIG. 8B is a table showing whether a drum ghost has appeared through the experiment 1;

FIG. 9A is a table showing whether banding has appeared through an experiment 1-4;

FIG. 9B is a table showing whether a drum ghost has appeared through the experiment 1;

FIG. 10A, FIG. 10B, and FIG. 10C are schematic drawings each showing the drum ghost that appeared on the surface of the photoconductor drum;

FIG. 11 is a graph showing maximum pressure PM of a nip region relative to a load N of the primary transfer roller, measured when an offset amount F was set to 0 mm, 2.0 mm, 4.0 mm, and 6.0 mm; and

FIG. 12 is a graph showing mottle indices relative to the maximum pressure PM of the nip region, acquired when the offset amount F was set to 0 mm, 2.0 mm, 4.0 mm, and 6.0 mm.

### DETAILED DESCRIPTION

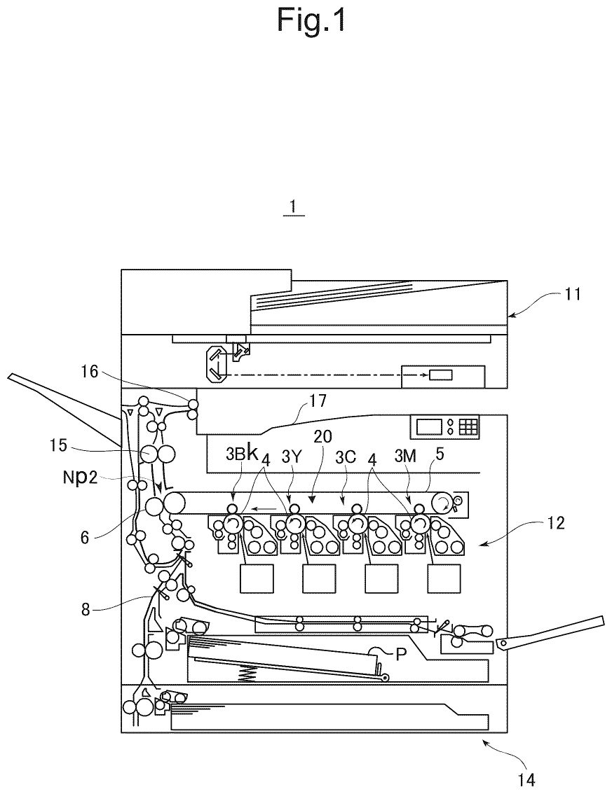

Hereafter, an image forming apparatus according to some embodiments of the disclosure will be described, with reference to the drawings. FIG. 1 is a cross-sectional view showing the image forming apparatus according to a first embodiment of the disclosure. The image forming apparatus 1 includes an image reading device 11 and an image forming device 12.

The image reading device 11 includes an image sensor that optically reads the image of a document. An analog output from the image sensor is converted into a digital signal, and image data representing the image of the document is generated.

The image forming device 12 serves to print the image represented by the image data, on a recording sheet P, and includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged and exposed, to thereby form an electrostatic latent image on the surface of the photoconductor drum 4, and then the electrostatic latent image on the surface of the photoconductor drum 4 is developed into a toner image, which is transferred to an intermediate transfer belt 5 in an intermediate transfer unit. As result, a colored toner image is formed on the intermediate transfer belt 5. The colored toner image is transferred, as secondary transfer, to the recording sheet P transported from a sheet feeding device 14 along a transport route 8, at a nip region NP2 between the intermediate transfer belt 5 and a secondary transfer roller 6.

Thereafter, a fixing device 15 heats and presses the recording sheet P, to fix the toner image onto the recording sheet P, by thermal compression, and then the recording sheet P is delivered to an output tray 17, via a delivery roller 16.

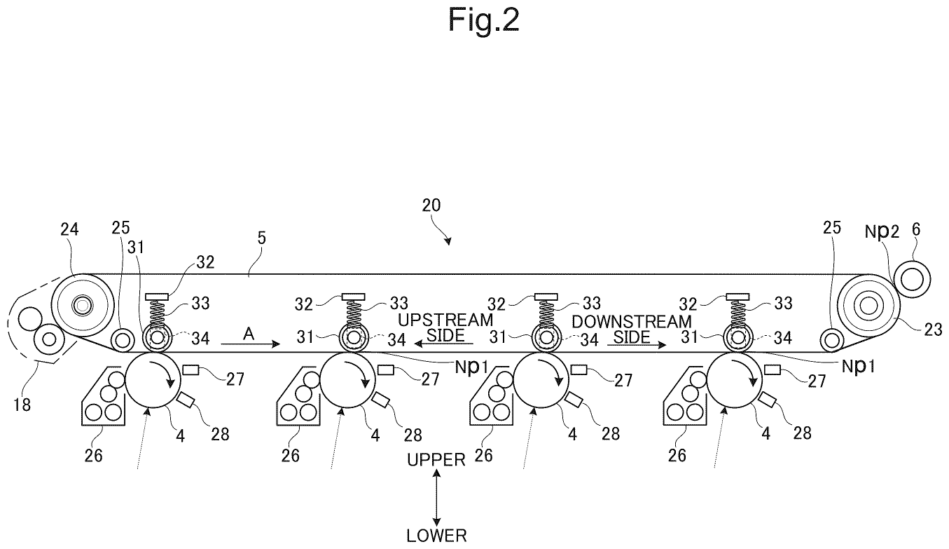

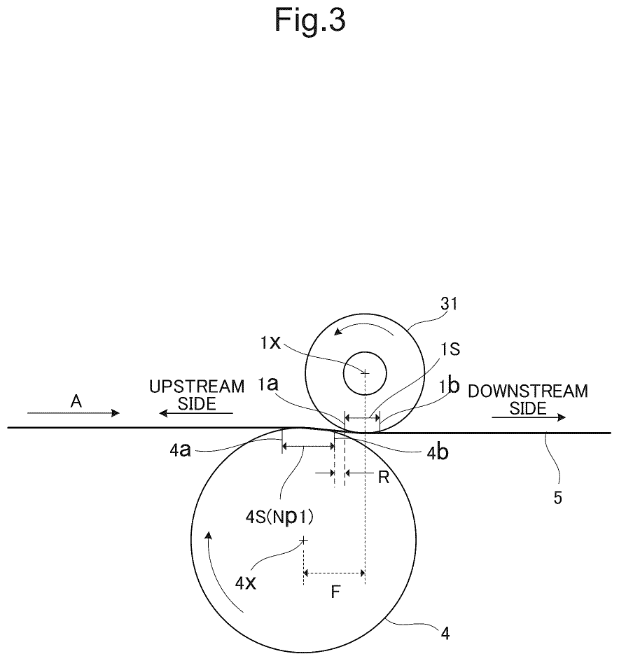

FIG. 2 is a side view showing an intermediate transfer unit 20. FIG. 2 illustrates the configuration of the intermediate transfer unit 20, seen from the opposite side of the image forming apparatus 1 shown in FIG. 1. As shown in FIG. 2, the intermediate transfer unit 20 includes four primary transfer rollers 31, a drive roller 23, a tension roller 24, and two backup rollers 25 (not shown in FIG. 1). The intermediate transfer belt 5 is stretched around the drive roller 23, the tension roller 24, and the backup rollers 25, and the primary transfer rollers 31 are pressed against the respectively corresponding photoconductor drums 4, via the intermediate transfer belt 5. When the drive roller 23 is made to rotate, the intermediate transfer belt 5 revolves in contact with each of the photoconductor drums 4, so that the toner image of each color is transferred from the photoconductor drum 4 to the intermediate transfer belt 5. A belt cleaning device 18 removes the toner remaining on the surface of the intermediate transfer belt 5. The primary transfer rollers 31 each extend in the direction orthogonal to the moving direction A of the intermediate transfer belt 5, in other words in the width direction of the intermediate transfer belt 5. The rotation shaft 1x (see FIG. 3) of the intermediate transfer belt 5 also extends in the width direction.

A metal roller, for example formed of free cutting steel, stainless steel, or aluminum, may be employed as the primary transfer roller 31. However, the material of the primary transfer roller 31 is not specifically limited. Alternatively, a metal roller subjected to a surface treatment with an oxide film (e.g., anodizing), plating (e.g., electrolytic nickel plating), or an insulating paint (e.g., acrylic resin or polyurethane resin), may be employed as the primary transfer roller 31.

The backup rollers 25 are, as shown in FIG. 2, located on the front side and the rear side respectively, of the four sets of the photoconductor drum 4 and the corresponding primary transfer roller 31, in the moving direction A of the intermediate transfer belt 5. The backup roller 25 is, for example, a metal roller with knurled surface.

The primary transfer rollers 31 each have the rotation shaft supported by a bearing 34 provided on each of end portions of the primary transfer roller 31. The rotation shaft of the primary transfer roller 31 is movable in the up-down direction via the bearing 34. On the upper side of the bearing 34, a stopper 32 is provided, with a spacing from the bearing 34. Between the bearing 34 and the stopper 32, a compressed spring 33 is provided, to press the bearing 34 of the primary transfer roller 31 against the intermediate transfer belt 5, with the biasing force of the spring 33. Thus, the spring 33 is a pressing spring. Accordingly, the primary transfer roller 31 is pressed against the intermediate transfer belt 5, and is made to intrude into a side where the photoreceptor drum 4 is located, via the intermediate transfer belt 5. Here, the spring 33 corresponds to the biasing device in the disclosure.

On the lower side of the intermediate transfer belt 5, a developing device 26, a drum cleaning device 27, and a charging device 28 are provided for each of the photoconductor drums 4. The photoconductor drums 4 are each made to rotate in the direction indicated by arrows in FIG. 2, so that as the photoconductor drum 4 rotates, the surface thereof is uniformly charged by the charging device 28, and exposed by a non-illustrated exposure device. Accordingly, an electrostatic latent image is formed on the surface of the photoconductor drum 4, and toner is applied by the developing device 26 to the electrostatic latent image on the surface of the photoconductor drum 4, so that the electrostatic latent image is developed into a toner image, which is transferred, as primary transfer, to the surface of the intermediate transfer belt 5, with the pressure applied by the primary transfer roller 31. Thereafter, the surface of the photoconductor drum 4 is destaticized, and the residual toner on the surface of the photoconductor drum 4 is removed by the drum cleaning device 27.

As described above, a colored toner image, formed by overlaying the toner images on the surface of the respective photoconductor drums 4 on each other, is formed on the intermediate transfer belt 5, and such colored toner image is transferred, as secondary transfer, from the intermediate transfer belt 5 to the recording sheet P, at the nip region NP2 between the intermediate transfer belt 5 and the secondary transfer roller 6.

The image forming apparatus 1 according to this embodiment includes four sets of the photoconductor drum 4 and the primary transfer roller 31, each set being composed of the photoconductor drum 4, and the primary transfer roller 31 opposed to the photoconductor drum 4 via the intermediate transfer belt 5. The sets of the photoconductor drum 4 and the primary transfer roller 31 are each located on the upstream side with respect to the secondary transfer roller 6, in the moving direction A of the intermediate transfer belt 5.

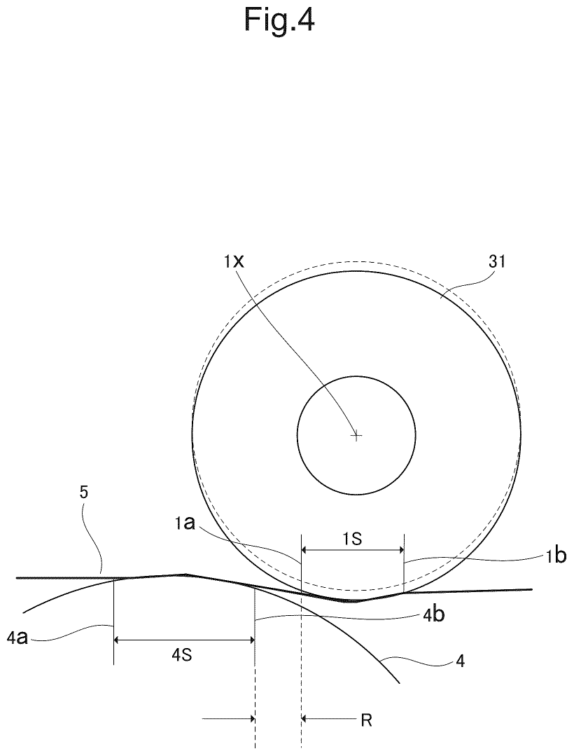

FIG. 3 is an enlarged schematic drawing showing the primary transfer roller 5, and one set of the photoconductor drum 4 and the primary transfer roller 31. FIG. 4 is a partially enlarged view from FIG. 3, showing the first contact region and the second contact region.

A first contact region 4S, representing the region on the photoconductor drum 4 in contact with the intermediate transfer belt 5, and a second contact region 1S, representing the region on the primary transfer roller 31 in contact with the intermediate transfer belt 5, are located so as not to overlap with each other. In FIG. 3 and FIG. 4, the overlapping amount is indicated by “R”.

Further, the summit of the primary transfer roller 31, protruding farthest toward the photoconductor drum 4 in the direction in which the photoconductor drum 4 and the primary transfer roller 31 are aligned across the intermediate transfer belt 5 (up-down direction in FIG. 3), is intruding into the side where the photoreceptor drum 4 is located via the intermediate transfer belt 5.

In this embodiment, the intrusion amount of the summit of the primary transfer roller 31 on the photoconductor drum 4, relative to an offset amount F representing the distance between the rotational center of the photoconductor drum 4 and that of the primary transfer roller 31, along the moving direction A of the intermediate transfer belt 5, is set to be in a predetermined proper range.

To be more detailed, when the upstream end of the first contact region 4S is denoted as 4a, the downstream end thereof is denoted as 4b, the upstream end of the second contact region 1S is denoted as 1a, and the downstream end thereof is denoted as 1b, in the moving direction A of the intermediate transfer belt 5, the upstream end 1a of the second contact region 1S is located on the upstream with respect to the downstream 4b of the first contact region 4S. In addition, when the rotational center of the photoconductor drum 4 is denoted as 4x, and the rotational center of the primary transfer roller 31 is denoted as 1x, the rotational center 1x of the primary transfer roller 31 is spaced from the rotational center 4x of the photoconductor drum 4 to the downstream side, in the moving direction A of the intermediate transfer belt 5, and an offset amount F, corresponding to the distance between the rotational center 4x and the rotational center 1x, is set to a value exceeding “0”.

The first contact region 4S is defined by the pressure exerted by the primary transfer roller 31 against the photoconductor drum 4, via the intermediate transfer belt 5. The first contact region 4S serves as a nip region NP1, where the toner image on the photoconductor drum 4 is transferred to the intermediate transfer belt 5.

In the second contact region 1S, the primary transfer roller 31 subjected to the transfer bias is pressed against the photoconductor drum 4, via the intermediate transfer belt 5. The pressure of the primary transfer roller 31, applied to the photoconductor drum 4 via the intermediate transfer belt 5 in the second contact region 1S, serves to enhance the transfer performance of the toner image from the photoconductor drum 4 to the intermediate transfer belt 5.

Between the primary transfer roller 31 being subjected to a transfer bias and the photoconductor drum 4 opposed to the primary transfer roller 31, a current flows via the intermediate transfer belt 5. To allow the toner image on the surface of the photoconductor drum 4 to be transferred to the intermediate transfer belt 5, a certain voltage is required between the primary transfer roller 31 and the photoconductor drum 4. However, for example when the first contact region 4S on the photoconductor drum 4 (nip region NP1) and the second contact region 1S on the primary transfer roller 31 are located at the same position in the moving direction A, the primary transfer roller 31 and the photoconductor drum 4 make contact with each other via the intermediate transfer belt 5, and since the primary transfer roller 31 is a metal roller, good conduction with scarce resistance is realized in the current path between the primary transfer roller 31 and the photoconductor drum 4 via the intermediate transfer belt 5. Therefore, it becomes difficult to attain a sufficient voltage for transferring the toner image, between the primary transfer roller 31 and the photoconductor drum 4.

In this embodiment, accordingly, the first contact region 4S on the photoconductor drum 4 with the intermediate transfer belt 5 and the second contact region 1S on the primary transfer roller 31 with the intermediate transfer belt 5 are spaced from each other, as described above. However, the primary transfer roller 31 and the photoconductor drum 4, opposed to each other, each make contact with the intermediate transfer belt 5. Separating thus the primary transfer roller 31 and the photoconductor drum 4 opposed to each other enables the resistance between the primary transfer roller 31 and the photoconductor drum 4 to be increased, when the transfer bias is applied, compared with the case where the primary transfer roller 31 and the photoconductor drum 4 are in contact with each other via the intermediate transfer belt 5. In other words, since the current flows from the primary transfer roller 31 to the photoconductor drum 4, which is spaced therefrom, through the intermediate transfer belt 5, and therefore the resistance generated by the intermediate transfer belt 5 is increased, compared with the case where the primary transfer roller 31 and the photoconductor drum 4 are in contact with each other via the intermediate transfer belt 5. With such resistance generated by the intermediate transfer belt 5, the sufficient voltage for transferring the toner image can be attained, between the primary transfer roller 31 and the photoconductor drum 4.

Here, when the first contact region 4S on the photoconductor drum 4 with the intermediate transfer belt 5 and the second contact region 1S on the primary transfer roller 31 with the intermediate transfer belt 5 are spaced from each other, the surface of the intermediate transfer belt 5, running between the primary transfer roller 31 and the photoconductor drum 4, may flap, which may affect the transfer performance of the toner image. Accordingly, in this embodiment, the summit of the primary transfer roller 31, protruding farthest toward the photoconductor drum 4 in the direction in which the photoconductor drum 4 and the primary transfer roller 31 are aligned across the intermediate transfer belt 5, is made to intrude on the photoconductor drum 4 via the intermediate transfer belt 5, to prevent the surface of the intermediate transfer belt 5 running between the primary transfer roller 31 and the photoconductor drum 4 from flapping.

Further, when the summit of the primary transfer roller 31 is made to intrude on the photoconductor drum 4, the pressure at the nip region NP1 can be efficiently increased, without taking the trouble to increase the load imposed on the primary transfer roller 31 by the biasing force of the spring 33, primary transfer roller 31, and the pressure exerted against the photoconductor drum 4 by the intermediate transfer belt 5 in the nip region NP1 can be stabilized. As result, the load imposed on the photoconductor drum 4 and the intermediate transfer belt 5 is alleviated, which leads to a prolonged mechanical service life.

When the summit of the primary transfer roller 31 is made to intrude on the photoconductor drum 4 by an excessive amount, the primary transfer roller 31 squeezes the intermediate transfer belt 5 against the photoconductor drum 4 too strongly, and the intermediate transfer belt 5 makes excessively tight contact with the surface of the photoconductor drum 4. Although it is preferable that the surface of the photoconductor drum 4 is formed in a smooth arcuate plane, the surface may include slight dips and bumps, depending on the manufacturing accuracy of the photoconductor drum 4. In such a case, when the intermediate transfer belt 5 makes excessively tight contact with the surface of the photoconductor drum 4, the unevenness on the drum surface may deform the surface of the intermediate transfer belt 5 running in contact with the photoconductor drum 4, thereby impairing the planarity of the surface of the intermediate transfer belt 5. As result, the toner image on the photoconductor drum 4 may fail to be transferred to the intended region on the intermediate transfer belt 5, thus failing to overlap with the toner image of another color transferred to the intermediate transfer belt 5, at the appropriate position, and what is known as color shift may be incurred. In addition, when the offset amount F is excessively increased, the pressure at the nip region NP1 is reduced and destabilized, and the transfer performance of the toner image from the photoconductor drum 4 to the intermediate transfer belt 5 may become unstable.

In this embodiment, therefore, the intrusion amount of the summit of the primary transfer roller 31 on the photoconductor drum 4, relative to the offset amount F, is set to be in the predetermined proper range, to prevent the mentioned drawbacks.

### Specific Example of Embodiment

In this example, the diameter of the photoconductor drum 4 is 30 mm, and the diameter of the primary transfer roller 31 is 12 mm. The primary transfer roller 31 is a metal roller.

As described above, when (i) the first contact region 4S on the photoconductor drum 4 with the intermediate transfer belt 5, and the second contact region 1S on the primary transfer roller 31 with the intermediate transfer belt 5 are spaced from each other, (ii) the offset amount F, corresponding to the distance between the rotational center 4x of the photoconductor drum 4 and the rotational center 1x of the primary transfer roller 31, along the moving direction A of the intermediate transfer belt 5, is set to be in a range of |1.0| mm≤F≤|10.0| mm, and (iii) the proper range of the intrusion amount Kr of the summit 1c of the primary transfer roller 31 on the photoconductor drum 4 is set to be between 0.1 mm and 1.5 mm, both ends inclusive, the image quality can be improved, and the mechanical service life can be prolonged.

Further, when (i) the first contact region 4S on the photoconductor drum 4 with the intermediate transfer belt 5, and the second contact region 1S on the primary transfer roller 31 with the intermediate transfer belt 5 are spaced from each other, (ii) the offset amount F, corresponding to the distance between the rotational center 4x of the photoconductor drum 4 and the rotational center 1x of the primary transfer roller 31, along the moving direction A of the intermediate transfer belt 5, is set to be in a range of |4.0| mm≤F≤|8.0| mm, and (iii) the proper range of the intrusion amount Kr of the summit 1c of the primary transfer roller 31 on the photoconductor drum 4 is set to be between 0.1 mm and 1.5 mm, both ends inclusive, the mentioned advantageous effects that the image quality can be improved, and the mechanical service life can be prolonged, can be surely attained.

A load N, imposed on the primary transfer roller 31 by the biasing force of the spring 33, is determined according to the size of the recording sheet. Since the spring 33 is, as already described, biasing the primary transfer roller 31 toward the intermediate transfer belt 5, thereby pressing the primary transfer roller 31 against the photoconductor drum 4 via the intermediate transfer belt 5, the load N can be set to an appropriate value by adjusting the biasing force of the spring 33, in addition to the settings specified as (i), (ii), and (iii) above.

For example, (iv) when the maximum size of the recording sheet is the standard A3, and the width of the intermediate transfer belt 5 is designed so as to fit the A3 size, it is preferable to set the load N, to be applied to the primary transfer roller 31 by the biasing force of the spring 33, to be in a range between 0.6 N and 3.0 N, both ends inclusive. In addition, (v) when the maximum size of the recording sheet is the standard A4, and the width of the intermediate transfer belt 5 is designed so as to fit the A4 size, it is preferable to set the load N, to be applied to the primary transfer roller 31 by the biasing force of the spring 33, to be in a range between 0.6 N and 1.4 N, both ends inclusive. Further, (vi) when an elastic belt is employed as the intermediate transfer belt 5, it is preferable to set the load N, applied to the primary transfer roller 31 by the spring 33, to be in a range between 0.2 N and 5.0 N, both ends inclusive. In such cases, the pressure applied to the intermediate transfer belt 5, per unit area thereof, can be set to an appropriate level. The elastic belt, also called an intermediate transfer belt with elastic layer, is formed by stacking a plurality of layers, including the elastic layer.

Further, one of the following conditions may be adopted, in addition to the conditions of (i), (ii), and (iii), and the combination of (i), (ii) (iii) and one of (iv) to (vi).

When a resin belt is adopted as the intermediate transfer belt 5, the thickness of the intermediate transfer belt 5 is set to be in a range from 30 μm to 150 μm, both ends inclusive. The resin belt includes, for example, a coating layer provided over the surface of the resin belt. When the elastic belt is employed as the intermediate transfer belt 5, the thickness of the intermediate transfer belt 5 is set to be in a range between 30 μm and 400 μm, both ends inclusive.

In addition, the tension of the intermediate transfer belt 5 is set to be in a range from 15 N to 45 N, both ends inclusive.

Further, a transfer current It, flowing between the primary transfer roller 31 and the photoconductor drum 4, when the transfer bias is being applied to the primary transfer roller 31, is set to be in a range of |2.0 μA|≤It≤|40.0 μA|.

Preferably, the transfer current It may be set to be in a range from −3.0 μA to −15.0 μA, both ends inclusive, according to the permittivity of the photoconductor drum 4, and the type of the toner.

### Experiment 1

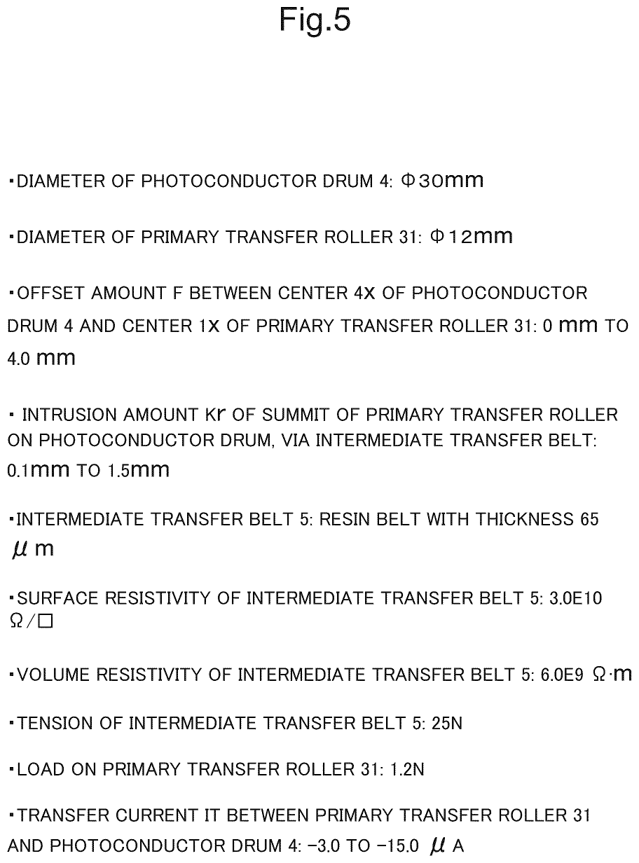

The conditions of the experiment 1 are as shown in FIG. 5. The diameter of the photoconductor drum 4 was set to 30 mm, and the diameter of the primary transfer roller 31 was set to 12 mm, as in the mentioned specific examples of this embodiment.

According to the conditions of the experiment 1, the offset amount F, between the rotational center 4x of the photoconductor drum 4 and the rotational center 1x of the primary transfer roller 31, along the moving direction A of the intermediate transfer belt 5, is set to 4.0 mm.

According to the conditions of the experiment 1, further, a resin belt having a thickness of 65 μm is adopted as the intermediate transfer belt 5. The surface resistivity of the intermediate transfer belt 5 is 3.0 E10 Ω/□ (ohms per square), and the volume resistivity of the intermediate transfer belt 5 is 6.0 E9 Ω·m.

According to the conditions of the experiment 1, further, the tension of the intermediate transfer belt 5 is set to 25 N. The load imposed on the primary transfer roller 31 by the spring 33 is set to 1.2 N.

According to the conditions of the experiment 1, still further, the transfer current It flowing between the primary transfer roller 31 and the photoconductor drum 4 is set to be in a range from −3.0 to −15.0 μA, both ends inclusive.

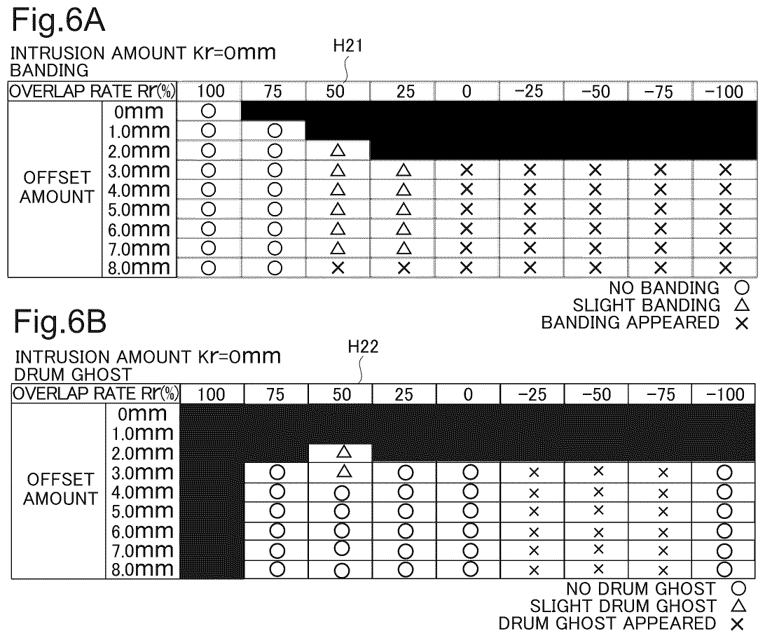

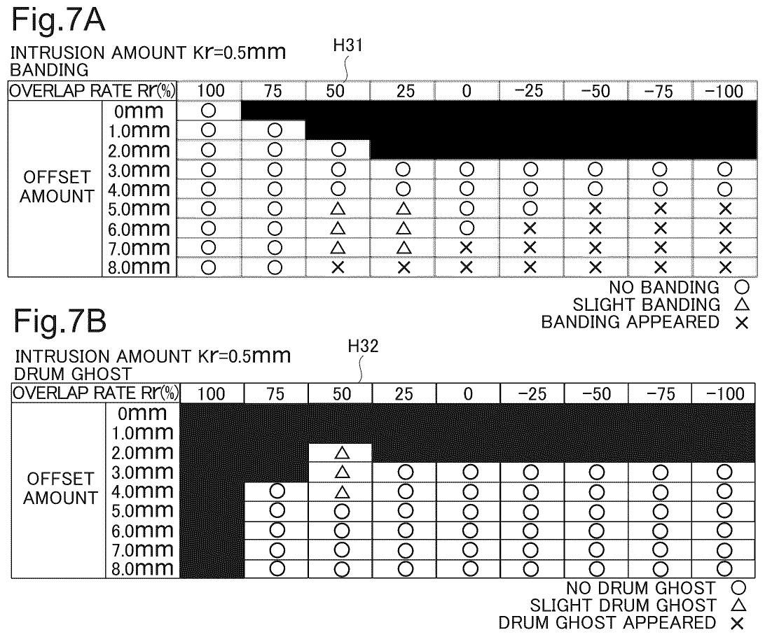

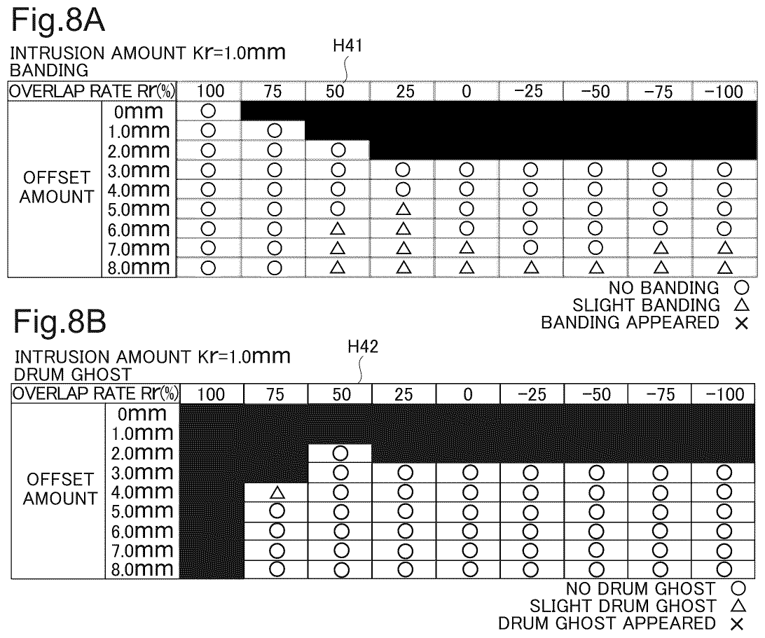

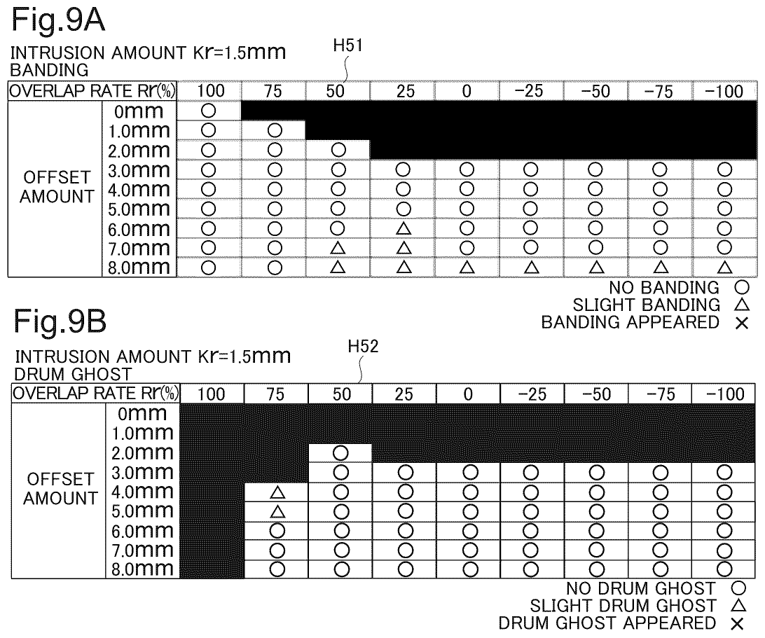

The experiment 1 includes four phases, namely an experiment 1-1, an experiment 1-2, an experiment 1-3, and an experiment 1-4, in each of which the intrusion amount Kr was set to a different value. The results of the experiment 1-1 are shown in a table H21 and a table H22 of FIG. 6A and FIG. 6B, respectively, the results of the experiment 1-2 are shown in a table H31 and a table H32 of FIG. 7A and FIG. 7B, respectively, the results of the experiment 1-3 are shown in a table H41 and a table H42 of FIG. 8A and FIG. 8B, respectively, and the results of the experiment 1-4 are shown in a table H51 and a table H52 of FIG. 9A and FIG. 9B, respectively.

For the experiment 1-1, the intrusion amount Kr was set to 0 mm, for the experiment 1-2 the intrusion amount Kr was set to 0.5 mm, for the experiment 1-3 the intrusion amount Kr was set to 1.0 mm, and for the experiment 1-4 the intrusion amount Kr was set to 1.5 mm.

In each of the experiments 1-1 to 1-4, the offset amount F was changed stepwise, and the overlap area Rs was also changed stepwise with respect to each of the offset amounts F, to evaluate the appearance of the banding and a drum ghost. A circle indicates that the banding or the drum ghost was not observed, a triangle indicates that banding or the drum ghost was slightly observed, and a cross indicates that the banding or the drum ghost was observed. Here, the drum ghost refers to such a phenomenon that a trace of the previously transferred image remains on the surface of the photoconductor drum 4, and such trace is overlaid on the next image. The drum ghost is also called a transfer memory.

In each of the experiments 1-1 to 1-4, the offset amount F was changed stepwise as 0 mm, 1.0 mm, 2.0 mm, 3.0 mm, 4.0 mm, 5.0 mm, 6.0 mm, 7.0 mm, and 8.0 mm, and the overlap rate Rr was changed stepwise as 100%, 75%, 50%, 25%, 0%, −25%, −50%, −75%, and −100%, with respect to each step of the offset amount F, to evaluate the appearance of the banding and the drum ghost.

The term “overlap” herein used refers to the state where the second contact region 1S and the first contact region 4S are overlaid on each other, along the moving direction A. The overlap area Rs assumes a maximum value RM, when the photoconductor drum 4 and the primary transfer roller 31 are in contact with the same position on the intermediate transfer belt 5 in the moving direction A (positions coinciding with each other on the front side and the back side of the intermediate transfer belt 5). The overlap rate Rr indicates the ratio of the overlap area Rs with respect to the maximum value RM of the overlap area Rs. When the overlap rate Rr assumes a negative value, the second contact region 1S and the first contact region 4S are spaced from each other, by the overlap area Rs corresponding to the overlap rate Rr.

According to the conditions of the experiment 1-1, as shown in the table H21 and table H22 of FIG. 6A and FIG. 6B, respectively, the intrusion amount Kr was set to 0 mm, and the overlap rate Rr was changed stepwise, with respect to each step of the offset amount F, to evaluate the appearance of the banding and the drum ghost.

Columns that are blacked out in each of the tables of FIG. 6A, FIG. 6B to FIG. 9A, FIG. 9B indicate that the evaluation of the banding and the drum ghost was not performed under the corresponding conditions.

According to the tables of FIG. 6A, FIG. 6B to FIG. 9A, and FIG. 9B, the evaluation of the appearance of the banding and the drum ghost was not performed when the offset amount F was set to 0 mm, because the rotational center 1x of the primary transfer roller 31 is located right above the rotational center 4x of the photoconductor drum 4, and the intrusion amount Kr was set to 0 mm and unchangeable.

According to the table H21 and the table H22 of FIG. 6A, FIG. 6B (intrusion amount Kr=0 mm) showing the results of the experiment 1-1, when the offset amount F was set stepwise from 1.0 mm to 10.0 mm, and the overlap rate Rr was set to 0% to −100%, the banding was observed at each step of the overlap rate Rr, and the drum ghost was not observed when the overlap rate Rr was set to 0%, was observed when the overlap rate Rr was from −25 to −75%, and was not observed when the overlap rate Rr was set to −100%.

According to the conditions of the experiment 1-2, as shown in the table H31 and the table H32 of FIG. 7A and FIG. 7B, respectively, the intrusion amount Kr was set to 0.5 mm, and the overlap rate Rr was changed stepwise, with respect to each step of the offset amount F, to evaluate the appearance of the banding and the drum ghost.

According to the table H31 and the table H32 of FIG. 7A and FIG. 7B, the banding was not observed, and the drum ghost was not observed either, when the overlap rate Rr was set to 0% to −100%, with respect to the offset amount F set to 3.0 mm and 4.0 mm. In addition, the banding was not observed, and the drum ghost was not observed either, when the overlap rate Rr was set to 0% to −25%, with respect to the offset amount F set to 5.0 mm.

According to the conditions of the experiment 1-3, as shown in the table H41 and the table H42 of FIG. 8A and FIG. 8B, respectively, the intrusion amount Kr was set to 1.0 mm, and the overlap rate Rr was changed stepwise, with respect to each step of the offset amount F, to evaluate the appearance of the banding and the drum ghost.

According to the table H41 and the table H42 of FIG. 8A and FIG. 8B, the banding was not observed or slightly observed, and the drum ghost was not observed, when the overlap rate Rr was from 0% to −100%, with respect to the offset amount F set to each of 3.0 mm to 8.0 mm. At each step where the offset amount F was set to 7.0 mm and 8.0 mm, the banding was not observed or slightly observed, and the drum ghost was not observed, when the overlap rate Rr was set to 0% to −100%.

According to the conditions of the experiment 1-4, as shown in the table H51 and the table H52 of FIG. 9A and FIG. 9B, respectively, the intrusion amount Kr was set to 1.5 mm, and the overlap rate Rr was changed stepwise, with respect to each step of the offset amount F, to evaluate the appearance of the banding and the drum ghost.

According to the table H51 and the table H52 of FIG. 9A and FIG. 9B, the banding was not observed or slightly observed, and the drum ghost was not observed, when the overlap rate Rr was from 0% to −100%, with respect to the offset amount F set to each of 3.0 mm to 8.0 mm. Here, when the offset amount F was set to 8.0 mm, the banding was slightly observed, and the drum ghost was not observed, at each step of the overlap rate Rr from 0% to −100%.

Through comparison among the tables of FIG. 6A, FIG. 6B to FIG. 9A, FIG. 9B, it is understood that setting the intrusion amount Kr to 1.0 mm to 1.5 mm, the offset amount F to 3.0 mm to 8.0 mm, and the overlap rate Rr to 0% to −100% is advantageous to suppressing the appearance of the banding and the drum ghost. When the intrusion amount Kr was set to 0.5 mm, setting the offset amount F to 3.0 mm or 4.0 mm and the overlap rate Rr to 0% to −100%, or setting the offset amount F to 5.0 mm and the overlap rate Rr to 0% to −25%, is advantageous to suppressing the appearance of the banding and the drum ghost. From the above, it may be presumed that the appearance of the banding and the drum ghost primarily depends on the setting of the intrusion amount Kr and the offset amount F.

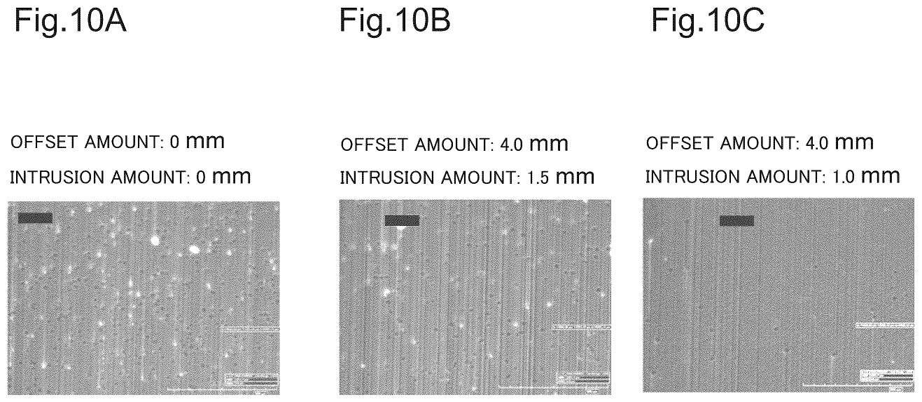

FIG. 10A presents the drum ghost that appeared on the surface of the photoconductor drum 4, when the intrusion amount Kr was 0 mm and the offset amount F was 0 mm. In FIG. 10A, the drum ghost can be prominently observed. FIG. 10B presents the drum ghost that appeared on the surface of the photoconductor drum 4, when the intrusion amount Kr was 1.5 mm, the offset amount F was 4.0 mm, and the overlap rate Rr was equal to or larger than 50%. In FIG. 10B, the drum ghost can be slightly observed. FIG. 10C presents the drum ghost that appeared on the surface of the photoconductor drum 4, when the intrusion amount Kr was 1.0 mm, the offset amount F was 4.0 mm, and the overlap rate Rr was equal to or less than 25%. In FIG. 10C, the drum ghost has disappeared.

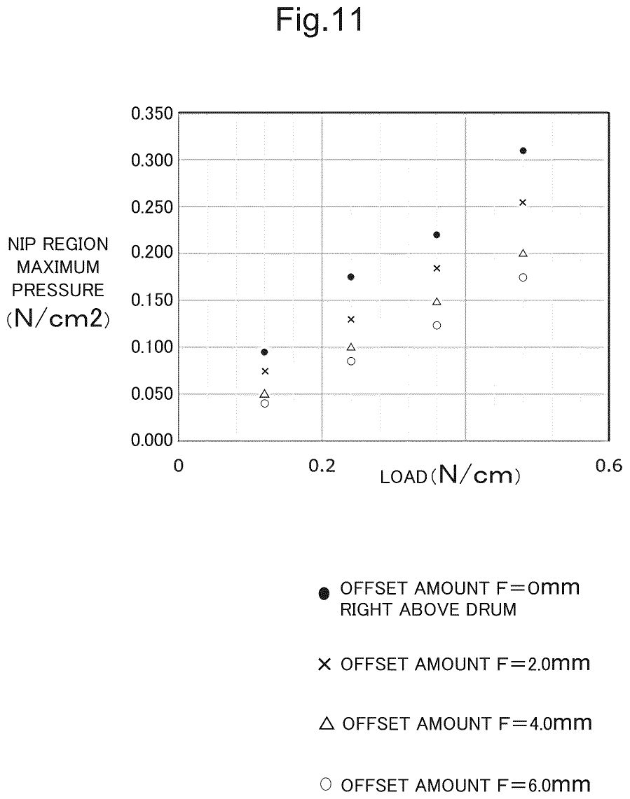

In the graph of FIG. 11, the horizontal axis represents the load N of the primary transfer roller 31, based on the biasing force of the spring 33, and the vertical axis represents the maximum pressure PM at the nip region NP1. The graph indicates the maximum pressure PM relative to the load N, measured when the offset amount F was set to 0 mm, 2.0 mm, 4.0 mm, and 6.0 mm, and the summit 1c of the primary transfer roller 31 was made to intrude on the photoconductor drum 4 via the intermediate transfer belt 5, by an intrusion amount Kr exceeding 0 mm and equal to or less than 0.5 mm, in the state where the overlap rate Rr was set to be in a range exceeding 0% and equal to or less than 25%. As is apparent from the graph of FIG. 11, when the offset amount F is increased, the maximum pressure PM at the nip region NP1 is reduced. This suggests that the pressure is dispersed over the entirety of the nip region NP1. Accordingly, the load imposed on the photoconductor drum 4 is alleviated, and the photoconductor drum 4 and the intermediate transfer belt 5 can be exempted from suffering a damage, which leads to prolonged service life of these components.

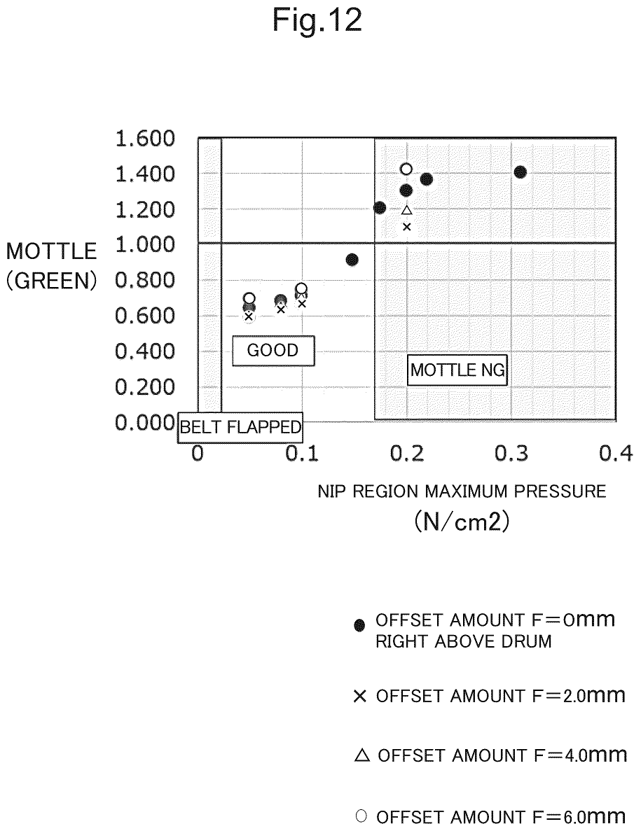

In the graph of FIG. 12, the horizontal axis represents the maximum pressure PM at the nip region NP1, and the vertical axis represents a mottle index indicating the graininess of the image, in a numerical form. The graph indicates the mottle index relative to the maximum pressure PM, acquired when the offset amount F was set to 0 mm, 2.0 mm, 4.0 mm, and 6.0 mm. The lower the mottle index is, the higher the image quality becomes, and therefore it is preferable to set the mottle index to a value lower than 1. As is apparent from the graph of FIG. 12, the mottle index can be set to a value lower than 1, when the maximum pressure PM at the nip region NP1 is 0.15 or lower. Presumably, this is because the adhesiveness of the toner on the surface of the intermediate transfer belt 5 is reduced, which leads to improved image quality.

Referring to FIG. 12, it is understood that, to set the maximum pressure PM at the nip region NP1 to a value equal to or lower than 0.15, it is preferable to appropriately adjust the load N applied to the primary transfer roller 31 by the biasing force of the spring 33, according to the size of the recording sheet (width of the intermediate transfer belt 5), and that, to attain a good result of the mottle index, it is preferable to set the offset amount F to 0 mm, 2.0 mm, 4.0 mm, or 6.0 mm.

From the above, it is understood that, when the second contact region 4S and the first contact region 1S are not overlapping with each other, the summit 1c of the primary transfer roller 31 formed of the metal roller is made to intrude on the photoconductor drum 4 via the intermediate transfer belt 5, and when the results of the experiments 1-1 to 1-4 shown in FIG. 6A, FIG. 6B to FIG. 9A, FIG. 9B are further taken into consideration, setting the intrusion amount Kr to 0.5 mm to 1.5 mm, and the offset amount F to 3.0 mm to 8.0 mm (more preferably, 3.0 mm to 5.0 mm) efficiently suppresses the appearance of the banding and the drum ghost. Therefore, it may be theoretically presumed that setting the intrusion amount Kr to 0.1 mm to 1.5 mm, and the offset amount F to 1.0 mm to 10.0 mm (more preferably, 4.0 mm to 8.0 mm) contributes to suppressing the appearance of the banding and the drum ghost.

According to the first embodiment, the upstream end 1a of the second contact region 1S is located on the downstream side with respect to the downstream 4b of the first contact region 4S, in the moving direction A of the intermediate transfer belt 5, and the rotational center 1x of the primary transfer roller 31 is spaced from the rotational center 4x of the photoconductor drum 4 to the downstream side, in the moving direction A of the intermediate transfer belt 5. Instead, as a second embodiment, the downstream end 1b of the second contact region 1S may be located on the upstream side with respect to the upstream end 4a of the first contact region 4S, and the center 1x of the primary transfer roller 31 may be spaced from the center 4x of the photoconductor drum 4 to the upstream side, to locate the first contact region 4S (nip region NP1) on the photoconductor drum 4, and the second contact region 1S on the primary transfer roller 31 so as not to overlap with each other. Such a configuration according to the second embodiment also provides, as in the first embodiment, the advantageous effects that, without the need to increase the spring load applied to the primary transfer roller 31, the image defect can be suppressed, and the mechanical service life of the photoconductor drum 4 and the intermediate transfer belt 31 can be prolonged. In addition, properly setting the offset amount F and the intrusion amount Kr further assures that the mentioned advantageous effects are attained. Taking the second embodiment into consideration, the direction in which the primary transfer roller 31 and the photoconductor drum 4 are offset from each other, along the moving direction of the intermediate transfer belt 5, becomes opposite to the setting according to the first embodiment. Therefore, the proper range of the offset amount F can be expressed as |1.0| mm≤F≤|8.0| mm, more preferably |3.0| mm≤F≤|8.0| mm, common to both of the first and second embodiments.

In some of the existing image forming apparatuses, the primary transfer roller is offset to the downstream side with respect to the photoconductor drum, and the region on the primary transfer roller in contact with the intermediate transfer belt, is spaced to the downstream side, from the region on the photoconductor drum in contact with the intermediate transfer belt. In the case of the image forming apparatus configured as above, the region on the photoconductor drum in contact with the intermediate transfer belt is spaced from the primary transfer roller. Accordingly, the nip region is spaced from the primary transfer roller. In such a case, the pressure applied to the recording sheet in the nip region is prone to become unstable, and an image defect (banding) arising from the revolving motion of the intermediate transfer belt may be incurred. In addition, increasing the spring load applied to the primary transfer roller, thereby increasing the pressure applied by the primary transfer roller to the photoconductor drum via the intermediate transfer belt, to avoid the mentioned drawback, leads to an increase in pressure in the nip region, which increases the load imposed on the photoconductor drum and the intermediate transfer belt, thereby shortening the mechanical service life of these components.

According to the foregoing embodiment, in contrast, the banding arising from the revolving motion of the intermediate transfer belt can be suppressed, so that the image quality is improved, and the mechanical service life of the photoconductor drum and intermediate transfer belt can be prevented from being shortened.

Further, the configurations described above with reference to FIG. 1 to FIG. 12 are merely exemplary, and in no way intended to limit the disclosure to those configurations.

While the present disclosure has been described in detail with reference to the embodiments thereof, it would be apparent to those skilled in the art that various changes and modifications may be made therein within the scope defined by the appended claims.

What is claimed is;

1. An image forming apparatus comprising:
a photoconductor drum that carries an electrostatic latent image, which is developed into a toner image by application of toner;
an intermediate transfer belt made to move in contact with the photoconductor drum; and
a primary transfer roller opposed to the photoconductor drum via the intermediate transfer belt, and configured to press the intermediate transfer belt against the photoconductor drum, thereby transferring the toner image on the photoconductor drum, to the intermediate transfer belt from the photoconductor drum, the primary transfer roller being a metal roller,
wherein a first contact region, being a region on the photoconductor drum in contact with the intermediate transfer belt, and a second contact region, being a region on the primary transfer roller in contact with the intermediate transfer belt, are kept from overlapping with each other, and
a summit of the primary transfer roller, protruding farthest toward the photoconductor drum, in a direction in which the photoconductor drum and the primary transfer roller are aligned across the intermediate transfer belt, is set to intrude into a side where the photoreceptor drum is located, via the intermediate transfer belt.

2. The image forming apparatus according to claim 1,
wherein an intrusion amount of the summit of the primary transfer roller into the side where the photoreceptor drum is located, relative to an offset amount corresponding to a distance between a rotational center of the photoconductor drum and a rotational center of the primary transfer roller in a moving direction of the intermediate transfer belt, is set to be in a predetermined proper range.

3. The image forming apparatus according to claim 2,
wherein the predetermined proper range of the intrusion amount is from 0.1 mm to 1.5 mm, both ends inclusive.

4. The image forming apparatus according to claim 3,
wherein an offset amount F, corresponding to a distance along a moving direction of the intermediate transfer belt, between a rotational center of the photoconductor drum and a rotational center of the primary transfer roller, is set to be in a range of |1.0| mm≤F≤|10.0| mm.

5. The image forming apparatus according to claim 4,
wherein an offset amount F, corresponding to a distance along a moving direction of the intermediate transfer belt, between a rotational center of the photoconductor drum and a rotational center of the primary transfer roller, is set to be in a range of |4.0| mm≤F≤|8.0| mm.

6. The image forming apparatus according to claim 1,
wherein a rotational center of the primary transfer roller is spaced from a rotational center of the photoconductor drum, to a downstream side in a moving direction of the intermediate transfer belt.

7. The image forming apparatus according to claim 1,
wherein a rotational center of the primary transfer roller is spaced from a rotational center of the photoconductor drum, to an upstream side in a moving direction of the intermediate transfer belt.

8. The image forming apparatus according to claim 1,
wherein, in a moving direction of the intermediate transfer belt, an upstream end of the second contact region is located on a downstream side with respect to a downstream end of the first contact region, and a rotational center of the primary transfer roller is spaced from a rotational center the photoconductor drum, to a downstream side.

9. The image forming apparatus according to claim 1,
wherein, in a moving direction of the intermediate transfer belt, a downstream end of the second contact region is located on an upstream side with respect to an upstream end of the first contact region, and a rotational center of the primary transfer roller is spaced from a rotational center the photoconductor drum, to an upstream side.

10. The image forming apparatus according to claim 1,
wherein a transfer current It, representing a current flowing between the primary transfer roller and the photoconductor drum, when a transfer bias is being applied to the primary transfer roller, is set to be in a range of |2.0 μA|≤It≤|40.0 μA|.

11. The image forming apparatus according to claim 1, further comprising a biasing device that biases the primary transfer roller thereby pressing the primary transfer roller against the intermediate transfer belt,
wherein a load applied to the primary transfer roller by the biasing device is set to be in a range between 0.6 N and 3.0 N, both ends inclusive.

12. The image forming apparatus according to claim 1, further comprising a biasing device that biases the primary transfer roller thereby pressing the primary transfer roller against the intermediate transfer belt,
wherein a load applied to the primary transfer roller by the biasing device is set to be in a range between 0.6 N and 1.4 N, both ends inclusive.

13. The image forming apparatus according to claim 1, further comprising a biasing device that biases the primary transfer roller thereby pressing the primary transfer roller against the intermediate transfer belt,
wherein the intermediate transfer belt is an elastic belt including an elastic layer, and
a load applied to the primary transfer roller by the biasing device is set to be in a range between 0.2 N and 5.0 N, both ends inclusive.

14. The image forming apparatus according to claim 1,
wherein, in a case where an elastic belt is employed as the intermediate transfer belt, a thickness of the intermediate transfer belt is set to be in a range between 30 μm and 400 μm, both ends inclusive, and in a case where a resin belt is employed as the intermediate transfer belt, a thickness of the intermediate transfer belt is set to be in a range between 30 μm and 150 μm, both ends inclusive.

15. The image forming apparatus according to claim 1,
wherein a tension of the intermediate transfer belt is set to be in a range between 15 N and 45 N, both ends inclusive.

16. The image forming apparatus according to claim 1,
wherein the primary transfer roller is a metal roller subjected to a surface treatment with an oxide film, plating, or an insulating paint.
